(19) United States
(12) Patent Application Publication
(10) Pub. No.: US 2024/0330714 A1
(43) Pub. Date: Oct. 3, 2024

(54) EVIDENCE-GUIDED FEASIBLE CONTRASTIVE EXPLANATION GENERATION

(71) Applicant: INTERNATIONAL BUSINESS MACHINES CORPORATION, Armonk, NY (US)

(72) Inventors: Sumanta Mukherjee, Bangalore (IN); Kanthi Sarpatwar, Briarcliff Manor, NY (US); Sattwati Kundu, Bangalore (IN); Raghunath E. Nair, Bangalore (IN); Shraddha Singh, Bangalore (IN); Roman Vaculin, Larchmont, NY (US)

(21) Appl. No.: 18/194,005

(22) Filed: Mar. 31, 2023

(51) Int. Cl. G06N 5/022; G06N 5/01

(52) U.S. Cl. CPC G06N 5/022; G06N 5/01

(57) ABSTRACT

Generating a contrastive explanation for a machine learning model prediction includes generating, by a multi-label joint autoencoder, latent embeddings of a plurality of machine learning model predictions. The latent embeddings are datapoints representing the plurality of predictions within an embedding space. The datapoints are positioned by the multi-label joint autoencoder within the embedding space based on a semantic labeling of each datapoint. Based on the latent embeddings, a plurality of computer-searchable data structures is generated. The computer-searchable data structures can identify a nearest flipped neighbor of datapoints within the embedding space. A nearest flipped neighbor determiner is output, the nearest flipped neighbor determiner constructed with the plurality of computer-searchable data structures.

### BACKGROUND

This disclosure relates to explainable artificial intelligence (XAI) and interpretable machine learning (iML), and, more particularly, to generating contrastive explanations for machine-generated decisions and predictions.

As artificial intelligence (AI) and machine learning become more advanced it is increasingly difficult for humans to understand how machine-generated decisions and predictions are reached. A machine-generated decision or prediction typically depends on an algorithm that can be difficult even for the engineers who created the algorithm to understand, let alone explain to a layperson, how the algorithm generated the outcome that it did. Nonetheless, explaining how a machine generates a decision or prediction can be important for many reasons. The explanation can help designers and developers ensure that a system functions as intended. The explanation may be necessary to meet certain regulatory standards. Moreover, an understanding of how a machine learning or other AI-endowed system generates decisions or predictions can assist an organization (e.g., a business) in effectively and efficiently applying such a system to specific tasks.

The goal of XAI and iML is to communicate to a human an understandable explanation as to why a black-box model made the prediction that it did. Conventional XAI and iML systems typically communicate which factors or features of an instance were most significant in generating a prediction. To understand how the prediction was generated, however, a human often wants to know what was lacking or different that led to one prediction rather than another. That is, the human may want a contrastive explanation. A contrastive explanation can communicate the minimal change in a feature of an instance that will “flip” (change) an AI or machine learning prediction. Although some systems do provide a contrastive explanation for a machine-generated prediction, conventional systems yet face challenges. The challenges include overcoming the so-called plateau effect and dealing with missing pertinent negatives. Moreover, conventional systems typically lack the extensibility needed for incorporating semantics into the search of a contrastive explanation.

### SUMMARY

In one or more embodiments, a method includes generating, by a multi-label joint autoencoder, latent embeddings of a plurality of machine learning model predictions. The latent embeddings represent the plurality of predictions as datapoints within an embedding space. The multi-label joint encoder positions the datapoints within the embedding space based on a semantic labeling of each datapoint. The method includes generating, based on the latent embeddings, a plurality of computer-searchable data structures. The method includes configuring a nearest flipped neighbor determiner based on the plurality of computer-searchable data structures for identifying a nearest flipped neighbor of datapoints within the embedding space.

Aspects of the method include the mitigation of the likelihood of missing pertinent negatives and the incorporation of semantics into the searches for contrastive explanations. The multi-label joint auto encoder satisfies all the properties of auto-encoding but additionally provides class separation within the embedding space. Joint embedding imposes separability in the embedding space. An explicit encoding of decision labels on the embedding space is enabled by the joint embedding.

The foregoing and other implementations can each optionally include one or more of the following features, alone or in combination. Some example embodiments include all of the following features in combination.

In one aspect, a contrastive explanation of a prediction generated by the machine learning model is determined based on a nearest flipped neighbor determined by the nearest flipped neighbor determiner. The nearest flipped neighbor determiner can determine the nearest flipped neighborhoods with soft constraints.

In another aspect, determining the contrastive explanation includes interpolating a datapoint within the embedding space representing the prediction and a datapoint within the embedding space representing the nearest flipped neighbor. The interpolating can include generating an optimal interpolation parameter using a greedy heuristic. The interpolation mitigates the problem of unrealistic or meaningless pertinent negatives in providing contrastive explanations.

In another aspect, a nearest flipped neighbor can be determined by a nearest flipped neighbor determiner that is configured as k-d tree. The k-d tree is a data structure that can be searched to identify a nearest flipped neighbor.

In another aspect, the machine learning model that generates a prediction explained by a contrastive explanation is a machine learning classifier that is trained to generate predictions by assigning an input to one of multiple classes. The nearest flipped neighbor determiner, accordingly, can comprise multiple k-d trees, each of the k-d trees uniquely corresponding to one of the multiple classes.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing a contrastive explanation generation (CEG) framework.

FIGS. 2A and 2B illustrate an example architecture for the executable CEG framework of FIG. 1.

FIG. 3 illustrates an example method of operation of the executable CEG framework of FIGS. 1 and 2.

FIG. 4 illustrates an example of a latent embedding of machine learning predictions generated by the executable CEG framework of FIGS. 1 and 2.

FIG. 5 illustrates certain operative aspects of a multi-label joint autoencoder implemented by the executable CEG framework of FIGS. 1 and 2.

FIG. 6 illustrates certain other operative aspects of the multi-label joint autoencoder implemented by the executable CEG framework of FIGS. 1 and 2.

FIGS. 7A-7C illustrate certain operative aspects of an example interpolator implemented by the executable CEG framework of FIGS. 1 and 2.

FIG. 8 illustrates certain other operative aspects of the example interpolator implemented by the executable CEG framework of FIGS. 1 and 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to XAI and iML, and, more particularly, to generating contrastive explanations for machine-generated decisions and predictions. Of the XAI and iML systems and techniques now available, many have been criticized for failing to provide explanations that adequately explain machine-generated decisions and predictions, at least in a manner typically understood by humans. When humans ask for an explanation of an outcome, they tend to contrast a given outcome with another one of interest. Thus, there is a human tendency to ask questions like “why this decision or prediction and not another”? “What is missing that led to this outcome in contrast to another”?

An explanation of a machine-generated decision or prediction based on what is missing is a contrastive explanation. A contrastive explanation can be machine-generated using pertinent negatives. The use of pertinent negatives is illustrated, for example, by the diagnosis of a patient who exhibits symptoms of cough and fever but not sputum or chills. Cough and fever can indicate flu or pneumonia. The absence of sputum and chills, however, precludes pneumonia. It is the absence of certain symptoms that confirms flu is the correct diagnosis. So, too, a machine-generated contrastive explanation can explain an outcome based on factors present as wells as factors not present. For example, in the context of a machine learning classifier, an input x̅ (e.g., feature vector) is classified in the class (or category) y not only because features f₁, . . . , fₖ are present but also because features fₘ, . . . , fₚ are not.

In the context of a machine learning classifier, for example, in which instances are represented by datapoints (e.g., feature vector in a vector space), a pertinent negative is a datapoint that is close to another datapoint but that is classified by the machine learning classifier in a different class or category. That is, both instances are close, per some distance metric (e.g., Euclidean or Manhattan distance, cosine similarity), but correspond to different machine learning predictions. A pertinent positive, by contrast, is a datapoint corresponding to a certain prediction (e.g., class or category) that is close to a base point, per the same distance metric, and corresponding to the same prediction as the base point. Pertinent negatives and pertinent positives are used by conventional contrastive explainers to generate contrastive explanations for predictions made by a model such as a machine learning classifier.

Nonetheless, in practice, conventional contrastive explainers confront several challenges. One challenge is the problem of so-called missing pertinent negatives. The problem is due to the “plateau effect” which can occur when a model is optimized using stochastic gradient descent. Stochastic gradient descent is a variant of the gradient descent used with backpropagation to minimize a loss function in fitting a neural network. Because with a conventional contrastive explainer the loss function—owing to the plateau effect—is flat over large regions, the conventional contrastive explainer does not converge and thus fails to provide an explanation of a model's prediction.

Another challenge is that of meaningless pertinent negatives. Contrastive explanations can be generated by determining the effect of varying a factor by changing the value of a feature in a feature vector. For example, if age is a feature of a feature vector, increasing the feature, say, to 120 is meaningless. Similarly, if average income (e.g., between $100,000 and $200,000) is a feature, increasing or decreasing income by one million to generate a contrastive explanation is likely meaningless.

A further challenge is semantical limitation. In a given context, it can be desirable to generate a domain-specific contrastive explanation of a machine-generated decision or prediction. For example, in a multi-echelon maintenance, repair, and operations (MRO) environment, a contrastive explanation can assist a smart controller in making recommendations with respect to inventory optimization (IO). To incorporate domain specificity into an MRO-IO context, semantically related datapoints should be grouped together. For example, providing a contrastive explanation of the movement of products into and out of inventory may require grouping datapoints representing products semantically related by being in high demand and moving and separating them from datapoints representing products that move only slowly. Semantically similar datapoints thus should be grouped together and spaced relatively farther apart from datapoints not semantically related.

In accordance with the inventive arrangements described herein, methods, systems, and computer program products are provided that are capable of incorporating domain-specific semantics into the generation of contrastive explanations while mitigating the plateau effect and handling missing pertinent negatives.

An aspect of the inventive arrangements is a multi-label joint autoencoder. The multi-label joint autoencoder is capable of generating latent embeddings within an embedding space of machine learning predictions. The latent embeddings can be used to construct joint-embedding structures. That is, data whose structure enables domain-specific searches for a nearest flipped neighbor within the embedding space. A “flipped neighbor” is a datapoint within the embedding space that a machine learning model assigns to a class or category that is different than that of its closest neighbor. The closeness is determined according to a predetermined distance metric over the embedding space. The datapoints within the embedding space are representations (e.g., vectors) of instances input to the machine learning model to generate a prediction (e.g., classification, regression).

Utilizing the joint-embedding data structures, the inventive arrangements can initially determine an auxiliary contrastive explanation of a prediction generated by the machine learning model. The inventive arrangements perform a unique interpolation to refine the auxiliary contrastive explanation, thereby generating a final contrastive explanation. The final contrastive explanation preserves a machine-generated prediction's meaning in the sense that the contrastive explanation is consistent with predetermined, domain-specific semantics of the data. “Domain-specific semantics” are predetermined relationships among the datapoints (instances) for which the machine learning model generates predictions. The relationships are defined by a quantitative, categorical, or other measure that groups the datapoints within the embedding space into sub-groups.

For example, in the context of inventory optimization, a domain-specific semantic may be used to segregate products into ones that move rapidly out of inventory and products that move only slowly. Quantitatively, the domain-specific semantic can be expressed by a predetermined threshold for time-in-inventory. Datapoint representations of instances (products) whose time-in-inventory feature is greater than the threshold are grouped in a common region within the embedding space distinct from instances whose time-in-inventory feature is less than the threshold. Those instances whose time-in-inventory is less than the threshold are similarly grouped within a distinct region of the embedding space. In another context, for example, a machine learning model's predictions determine whether a loan application is approved. A domain-specific semantic can be income levels. Income level can be a domain-specific semantic that separates datapoint representations of instances (loan applications) according to income level categories (e.g., low, middle, high).

An aspect of preserving semantic meaning is finding a nearest flipped neighbor by identifying a datapoint that lies in one embedding space region (corresponding to a semantic sub-grouping) who's prediction is different (flipped) from one that lies in a different region (corresponding to a different semantic sub-grouping). The datapoints are flipped because the machine learning model assigns a different prediction (e.g., class or category) to each. Yet, though near to one another, each retains its semantic meaning in that each lies within the embedding space in a region corresponding to the semantic meaning of each. For example, in the loan application context, one datapoint is that of an approved application based on the model prediction and the nearest neighbor is one not approved. Semantic meaning is preserved in that one neighbor lies in one region (high income level) and the other in a different one. Because one is the “nearest flipped neighbor” of the other, the relationships reveal a contrastive explanation that explains the minimal embedding space distance-corresponding to a difference in income-necessary to cause the machine learning prediction to flip.

Another aspect of the inventive arrangements is generation of realistic or meaningful pertinent negatives, as opposed to unrealistic or meaningless ones. As used herein, an “unrealistic” or “meaningless” pertinent negative means one that is extremely unlikely to occur in a given, real-life context. Quantitatively, an unrealistic or meaningless pertinent negative is one whose probability of occurring is less than a threshold value (e.g., less than 5%). For example, in the context of a $10,000 loan application, a pertinent negative of $1,000,000 to flip a machine-generated decision is unrealistic and not meaningful. So, too, for example is a pertinent negative corresponding to a human age of 120 years. By contrast, as used herein, a “meaningful” or “realistic” pertinent negative is one for which its occurrence is not unlikely and which corresponds to a realistic contrastive explanation.

Still another aspect of the inventive arrangements disclosed herein is implementation of a greedy heuristic. The greedy heuristic is an algorithm for determining an optimal interpolation of the auxiliary and the final contrastive explanations. The algorithm includes computing a difference vector between the auxiliary and the final contrastive explanations, ordering the coordinates of the difference vector, and performing a binary search to determine the optimal interpolation of the auxiliary and the final contrastive explanation.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

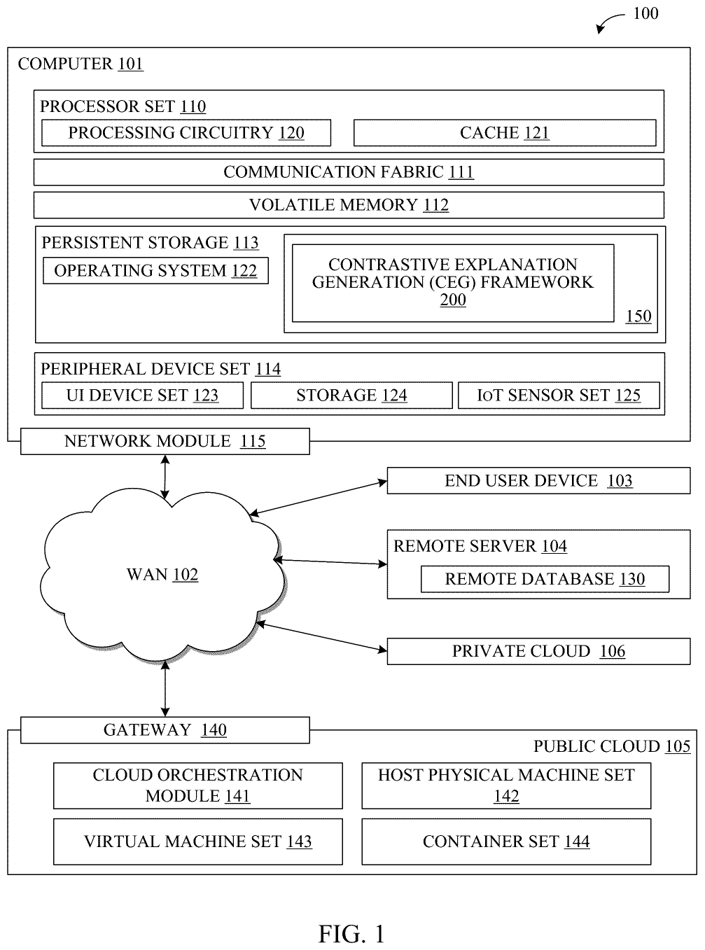

Referring to FIG. 1, computing environment 100 contains an example of an environment for the execution of at least some of the computer code in block 150 involved in performing the inventive methods, such as contrastive explanation generator (CEG) framework 200 implemented as executable program code or instructions. CEG framework 200 utilizes a multi-label joint autoencoder to generate a latent embedding of machine learning model predictions. The multi-label joint autoencoder can construct data structures within a domain-specific semantic embedding space that can be searched to identify a nearest flipped neighbor. The contrastive explanation preserves predefined semantic meanings. In certain embodiments, the nearest flipped neighbor is found by CEG framework 200 initially identifying an auxiliary contrastive explanation and determining a final contrastive explanation through interpolation. CEG framework 200, in certain embodiments, implements a greedy heuristic for performing the interpolation.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CEG framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

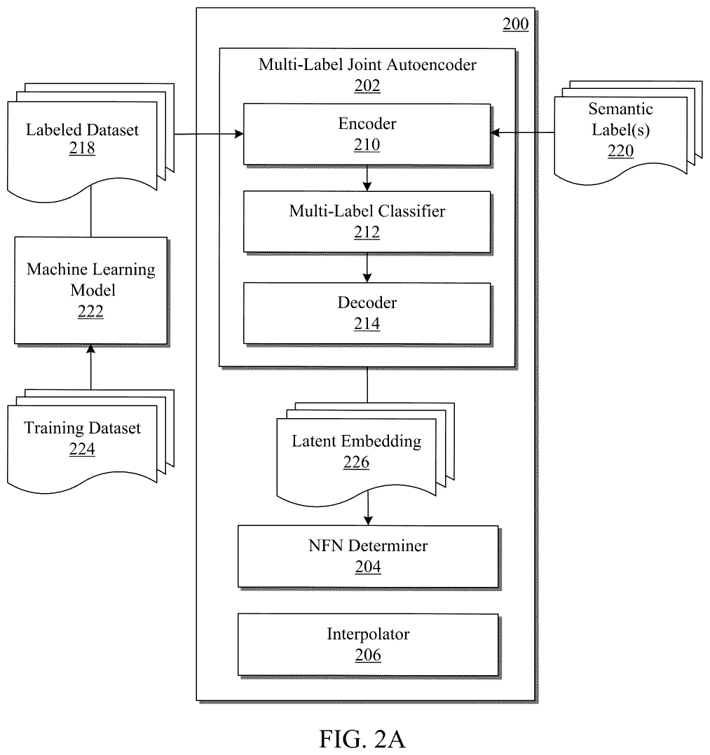

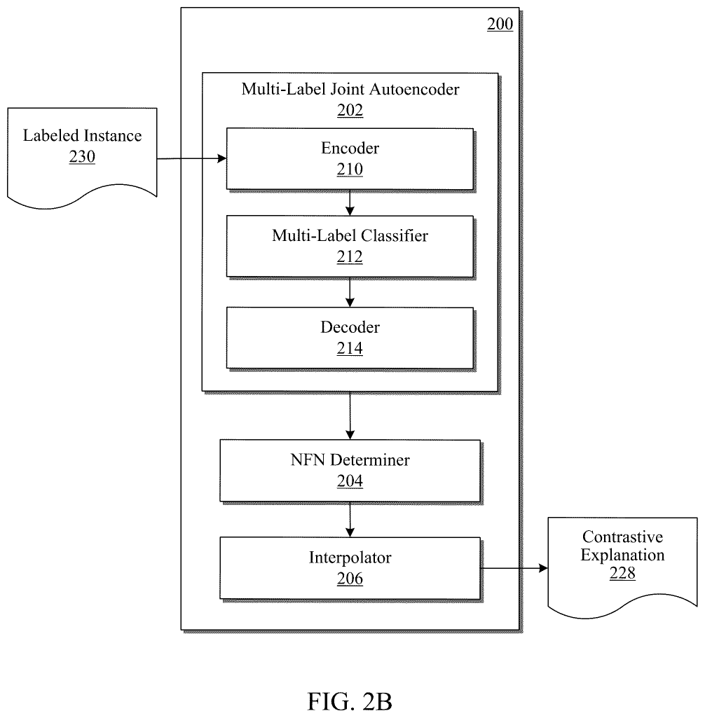

FIGS. 2A and 2B illustrate an example architecture for the executable CEG framework 200 of FIG. 1. In the example of FIGS. 2A and 2B, CEG framework 200 illustratively includes multi-label joint autoencoder 202, nearest flipped neighbor (NFN) determiner 204, and interpolator 206. In certain arrangements, multi-label joint autoencoder 202 comprises encoder 210, multi-label classifier 212, and decoder 214.

Operatively, multi-label joint autoencoder 202 utilizes the input of semantic labels to “position” (e.g., compute coordinates of) datapoints in an embedding space, the datapoints corresponding to machine-generated decisions of the model for which a contrastive explanation is sought. The datapoints are positioned by multi-label joint autoencoder 202 such that semantically similar points are relatively close to each other within the embedding space. Multi-label classifier implements 212 a classification model that generates labels and labels each datapoint. The labeled datapoints are used by MFN determiner 204 to determine flipped neighbors. Once multi-label joint autoencoder 202 is trained, the embeddings are determined for each datapoint. Accordingly, there is no further need for decoder 214 once multi-label joint autoencoder 202 is trained, as decoder 214 mainly operates to train encoder 210 according to a predetermined loss function. From labeled datapoints, the labels determined by the classification model, NFN 204 determines the nearest flipped neighbor. NFN 204, in accordance with certain embodiments, implements a k-d tree data structure, and as described below, uses interpolator 206 in determining a contrastive explanation. From a set of nearest flipped neighbors, a closest one to the datapoint representing a machine-generated decision or prediction (e.g., classification) is determined thereby indicating the contrastive explanation.

While conventional approaches generate pertinent negatives, they typically do so only artificially. The artificially generated pertinent negatives are not guaranteed to be meaningful or realistic. Such pertinent negatives are not guaranteed to converge to an optimal solution. The inventive arrangements of CEG framework 200, by contrast, provide a solution by anchoring the generation of the pertinent negatives to an auxiliary datapoint that is guaranteed to exist and is made part of the training data. Using linear interpolation as an optimization strategy, CEG framework 200 also guarantees generation of realistic and meaningful pertinent negatives. CEG framework 200 ensures meaningfulness by generating an auxiliary instance that is a realistic example of an event or condition that would flip a machine-generated prediction. Interpolation by CEG framework 200 ensures the datapoint representing a contrastive explanation is also guaranteed to preserve the meaningfulness. User-imposed constraints (e.g., business constraints) are incorporated by the embedding of datapoints within an embedding space such that semantically similar datapoints are grouped together using multi-label joint embedding.

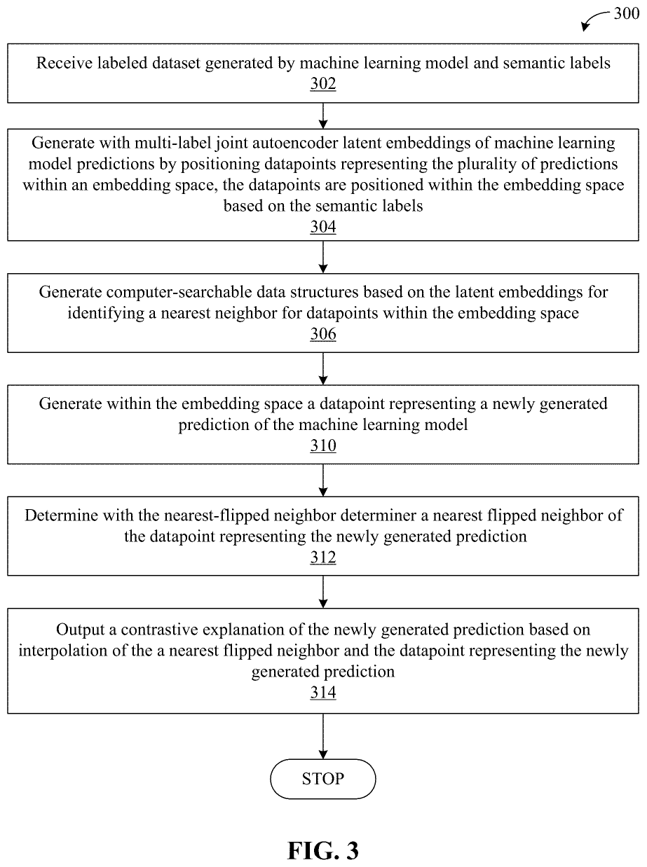

FIG. 3 illustrates an example method 300 of operation of the CEG framework 200 of FIGS. 1 and 2A and 2B. Blocks 302, 304, 306, and 308 correspond to operation of CEG framework 200 as illustrated in FIG. 2A with respect to multi-label joint autoencoder 202's generating latent embeddings and data structures to configure NFN determiner 204. Blocks 310, 312, and 314 correspond to operation of CEG framework 200 as illustrated in FIG. 2B with respect to generating contrastive examples by NFN determiner 204. In certain embodiments, CEG framework 200's generating contrastive examples optionally includes interpolating embedding space datapoints by interpolator 206.

Referring initially to FIGS. 2A and 3 collectively, in block 302, CEG framework 200 receives input comprising a labeled dataset 218 and semantic labels 220. Labeled dataset 218 comprises instances for which machine learning model 222 generates predictions. An instance of labeled dataset 218 is labeled with a prediction label corresponding to the prediction that machine learning model 222 generates for the instance. Semantic labels 220 are labels corresponding to one or more predefined semantic relationships among the instances. Semantic labels 220 are input to CEG framework 200 by a user and are automatically applied to the instances by CEG framework 200 based on the specific attributes or features of each instance.

Machine learning model 222 thus generates a prediction ŷ in response to an input (instance) to the model. The input can be an n-tuple, or vector, instance x̅ having n elements or features (e.g., feature vector) that corresponds to the specific attributes of the instance. Machine learning model 222 is trained with training dataset 224. If machine learning model 222 is a regression model, for example, then the prediction ŷ can be a scalar (real number) or a vector whose elements are real numbers indicating quantities. If machine learning model 222 is a classifier, for example, then the prediction ŷ is an indicator (categorical data element) that indicates the assignment of x̅ by the model to a specific class or category. Instances of labeled dataset 218 comprise the instances of training dataset 224, which have been labeled with a prediction label indicating the prediction generated for each by machine learning model 222. Thus, each instance of labeled dataset 218 can be represented by a datapoint (vector) that includes instance x̅ and prediction ŷ. [symbol] x̅, ŷ [symbol] , the prediction label of each instance corresponding to ŷ.

Semantic labels 220 are domain-specific labels that are supplied by the user. Multi-label joint autoencoder 202 utilizes the domain specificity of semantic labels 220 to identify instances x̅ that are semantically similar. For example, if machine learning model 222 is trained to predict (decide) whether a loan application is approved, then the semantic labels may be used to distinguish high-income applicants from low-income ones. If machine learning model 222 is trained to predict whether inventory items should be ordered, then the semantic labels may be used to distinguish high-demand items (whose inventory depletes more rapidly) from low-demand items.

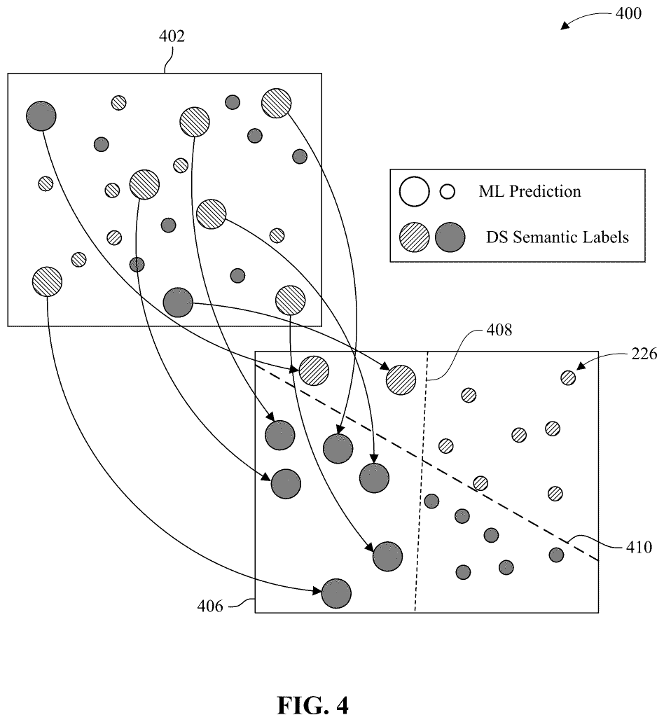

In block 304, multi-label joint autoencoder 202 generates latent embeddings 226 of a plurality of machine learning model predictions generated by machine learning model 222. Multi-label autoencoder generates latent embeddings 226 by positioning datapoints representing the plurality of predictions within an embedding space. The datapoints are positioned within the embedding space based on the semantic labeling of each datapoint. FIG. 4 illustrates an example generation 400 of latent embeddings 226. Illustratively, the predictions generated by machine learning model 222 are binary predictions (e.g., zero and one), represented by the large and small circles in dataspace 402. For example, machine learning model 222 can be a machine learning classifier, the predictions indicating to which of two classes each instance is assigned. Multi-label joint autoencoder 202 generates latent embeddings 226 (multi-dimensional datapoints) of the predictions in embedding space 406. Latent embeddings 226 are labeled with domain-specific labels, which are utilized by multi-label joint autoencoder 202 to group the predictions based on semantic similarity. Illustratively, the different semantic similarities of latent embeddings 226 are distinguished by light and dark shadings of the labels. Latent embeddings 226 are separated and grouped in embedding space 406 into four distinct regions. The different regions are generated by partitioning the embedding space with space-partitioning data structures. For example, in certain embodiments, described below, the partitioning is performed by generating k-d tree structures. Using k-d tree structures, the partitioned embedding space is created as a union of output-specific k-d trees that enable the efficient determination of nearest flipped neighbors, as described below. Illustratively, in the example of FIG. 4, hyperplane 408 separates latent embeddings 226 based on machine learning model 222's predictions, while hyperplane 410 separates latent embeddings 226 based on semantic similarities determined by multi-label joint autoencoder 202.

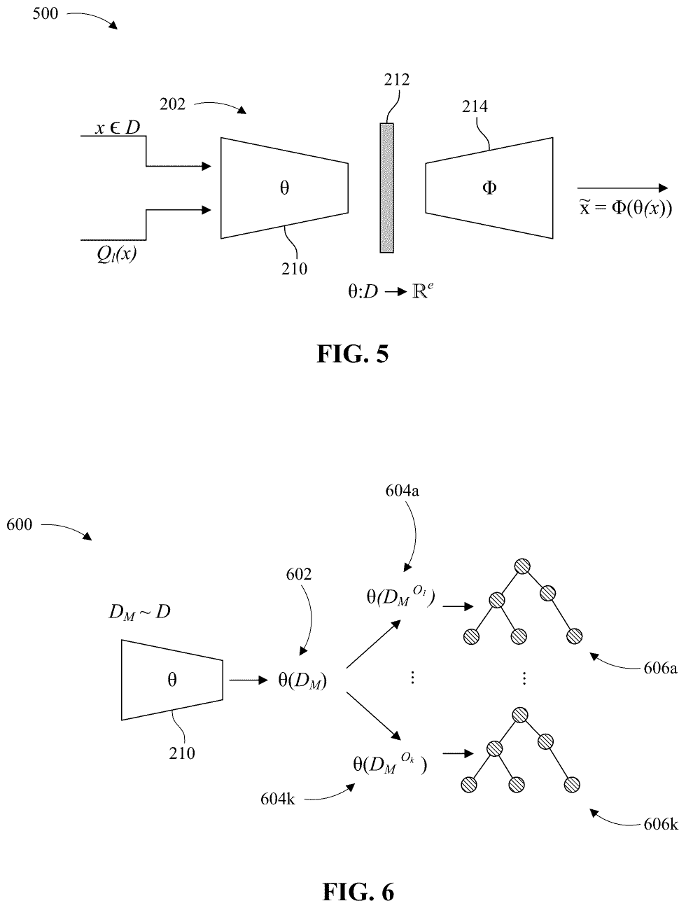

FIG. 5 illustrates certain operative aspects 500 of multi-label joint autoencoder 202 in generating latent embeddings 226. Encoder 210 of multi-label joint autoencoder 202 receives each instance of labeled dataset 218, denoted as x̅∈ [symbol] , along with semantic labels 220, [symbol] ∈[K], where K is the number of distinct domain-specific relations represented by semantic labels 220. Encoder 210 implements an encoder θ, which encodes the inputs [symbol] in a multi-dimensional embedding space [symbol] , θ: [symbol] → [symbol] . Multi-label classifier 212 implements domain-specific label mappings [symbol] : [symbol] → [symbol] for each [symbol] ∈[K]. Decoder 214 implements a decoder Φ that generates a reconstruction \tilde{x} of encoded x, where \tilde{x}=Φ(θ(x)). In certain embodiments, multi-label joint autoencoder 202 determines latent embeddings 226 according to the following loss function:

$${min}_{Θ , Φ} {𝔼}_{D} [ {‖ Φ ( Θ ( x ) ) - x ‖}^{2} ] + {Σ}_{ℓ ∈ [ K ]} {Σ}_{{x}_{i} , {x}_{j} ∈ 𝒟 : {Q}_{ℓ} ( x ) = {Q}_{ℓ} ( {x}_{j} )} {‖ Θ ( {x}_{i} ) - Θ ( {x}_{j} ) ‖}^{2} ,$$

which minimizes a sum of two terms, where the first term is the expected reconstruction error loss and the second term is a sum of distances between embeddings corresponding to datapoints having similar labels, summed over all the K labels.

Referring still to FIGS. 2A and 3, in block 306, multi-label joint autoencoder 202 generates computer-searchable data structures based on latent embeddings 226. The computer searchable data structures are utilized by CEG framework 200 to configure NFN determiner 204. NFN determiner 204 is uniquely configured with respect to machine learning model 222 to identify nearest neighbor datapoints within an embedding space of datapoints representing instances of labeled dataset 218. FIG. 6 illustrates certain other operative aspects 600 of multi-label joint autoencoder 202 pertaining to generating the computer-searchable data structures. In certain embodiments, encoder 210 samples M instances, [symbol] _{M}, of [symbol] (labeled dataset 218). For each of the M instances, [symbol] _{M}, encoder 210 constructs latent embeddings 602 of [symbol] _{M}: Θ( [symbol] _{M})={Θ(x): ∀x∈ [symbol] _{M}}. Multi-label joint autoencoder 202 partitions [symbol] _{M} into |O| sub-sets of [symbol] _{M} grouped according to the prediction labels indicating machine learning model 222's predictions ŷ for each of the corresponding datapoints: [symbol] ={x∈ [symbol] _{M}: [symbol] [x]=o}. (Note for readability and case of presentation indices of the distinct output labels, o, are omitted.) For each output label o∈O, encoder 210 constructs k-d tree structures 606a through 606k on each Θ( [symbol] ) 604a and 604k, respectively. Although shown by two k-d tree structures, the number of k-d tree structures 606a through 606k can be any positive integer.

Every node of k-d tree structures 606a through 606k is a k-dimensional point. Every non-leaf node of k-d tree structures 606a through 606k corresponds to a hyperplane that divides the embedding space into half-spaces. Embedding space datapoints to the left of the hyperplane are represented by the left subtree of that node. Datapoints to the right of the hyperplane are represented by the right subtree. A directional orientation of the hyperplane is determined by associating every node in a k-d tree with one of the k dimensions, the hyperplane being perpendicular to that dimension's axis. The axis perpendicular to the hyperplane is split such that datapoints on one side of the hyperplane (e.g., having lower values) appear in the left subtree and datapoints (e.g., having higher values) appear in the right subtree. The hyperplane can be set according to the datapoint value along the axis to which the hyperplane is perpendicular.

k-d tree structure 606a through 606k are capable of implementing a function T^{o}: [symbol] → [symbol] . Accordingly, in certain embodiments, encoder 210 upon constructing k-d tree structures 606a through 606k returns a function. T(x, o)=T^{o}(x) for determining a nearest neighbor of instance x whose prediction is indicated by label prediction label o. Operatively, for each label o of the set label O (o∈O) corresponding to a machine-generated prediction (e.g., classification), the nearest neighbor is determined from the k-d tree. For a given label o, the closest neighbor in the corresponding k-d tree is a nearest flipped neighbor. The closest neighbor of the k-d tree, by construction, is the nearest flipped neighbor with respect to the given label o. The nearest flipped neighbor per label o is a flipped neighbor candidate. From among the nearest flipped neighbor candidates, the closest one of the candidates is the nearest flipped neighbor of the machine-generated prediction from which the contrastive explanation is determined.

Referring still to FIGS. 2A and 3, operation of CEG framework 200's configuring NFA determiner 204 is illustrated. In block 308, CEG framework 200 configures NFN determiner 204 based on the computer-searchable data structures. NFN determiner 204, based the computer-searchable data structures, is uniquely configured to explain predictions generated by machine learning model 222, as trained with training set 224 specifically and in accordance with semantic relationships of semantic labels 218. In some embodiments, NFN determiner 204 is configured based on computer-searchable data structures comprise as one or more k-d tree structures illustrated by k-d tree structures 606a through 606k. k-d tree data structures 606a through 606k each can uniquely correspond to one of semantic labels 220 and can be searched to determine a nearest flipped neighbor of a datapoint representing an instance for which machine learning model 222 generates a prediction. As described hereafter, the nearest flipped neighbor is used to determine a contrastive explanation of the prediction.

Referring now to FIGS. 2B and 3, operation of CEG framework 200's determining contrastive explanation 228 is illustrated. Contrastive explanation 228 is generated for the prediction generated by machine learning model 222 for labeled instance 230, which is newly input to CEG framework 200. Newly input labeled instance 230 instance is labeled with a prediction label indicating the prediction (e.g., class or category of the instance) that is generated by machine learning model 222. In block 310, multi-label joint autoencoder 202 generates a datapoint representing newly input labeled instance 230. Multi-label joint autoencoder 202 positions the datapoint within an embedding space according to a semantic labeling of the datapoint. The datapoint can be labeled with a semantic label by multi-label classifier 212 of multi-label joint autoencoder 202. The label can be one of semantic labels 220 selected by multi-label classifier 212 based on the specific features or attributes of newly input labeled instance 230.

In block 312, NFN determiner 204 determines a nearest flipped neighbor of the datapoint representing newly input labeled instance 230. The nearest flipped neighbor can be determined by NFN determiner 204's searching computer-searchable data structures with which it is configured. The computer-searchable data structures, in certain embodiments, comprise one or more k-d tree structures as illustrated by k-d tree data structures 606a through 606k.

In block 314, CEG framework 200 outputs contrastive explanation 228 explaining the prediction generated by machine learning model 222 for the newly input label instance 230. In certain embodiments described in the following paragraphs, CEG framework 200 generates contrastive explanation 228 by interpolating the nearest flipped neighbor and the datapoint representing the newly input labeled instance 230, the instance having the prediction label indicating the prediction generated by machine learning model 222.

In generating contrastive explanation 228, multi-label joint autoencoder 202 initially generates for the newly input labeled instance 230, denoted xₑₓ, a latent embedding Θ(xₑₓ). Machine learning model 222's prediction is indicated by the prediction label oₑₓ= [symbol] (xₑₓ), where C(⋅) is the predictor (e.g., classifier or regression function) implemented by machine learning model 222. For each prediction label o∈O\oₑₓ, save that of the newly input instance xₑₓ, a nearest flipped neighbor to xₑₓ, denoted (xₑₓ⁺, Θ(xₑₓ⁺)), is determined by NFN determiner 204. Because a nearest neighbor has a prediction label different than that of instance xₑₓ, it is a flipped neighbor. That is, it is closer to xₑₓ than similarly labeled instances but corresponds to a different prediction (e.g., different class or category) than xₑₓ. Each of the different predictions, of which the number is |O|, will have a flipped neighbor of xₑₓ, but it is the one closest to xₑₓ that is the nearest flipped neighbor of xₑₓ used to generate contrastive explanation 228.

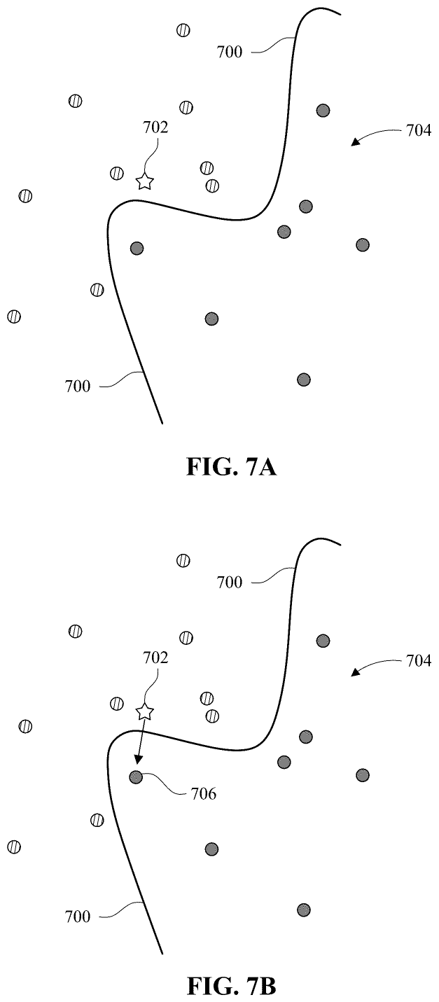

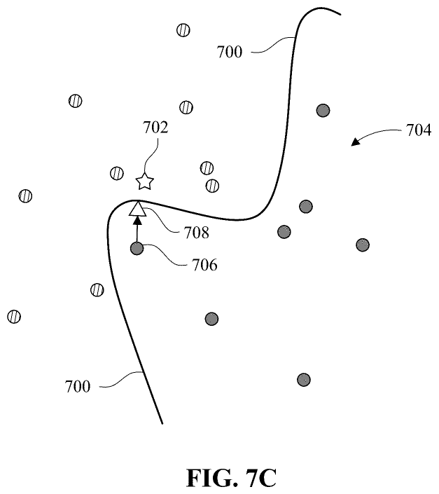

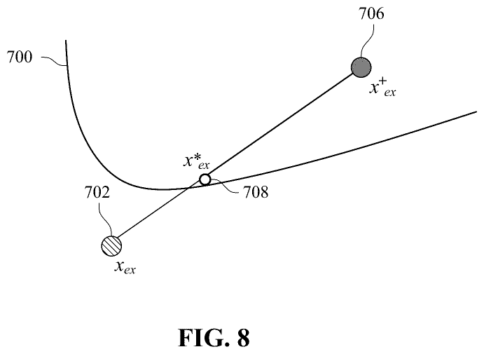

Referring now to FIGS. 7A-7C, certain operative aspects of CEG framework 200 are illustrated with respect to determining contrastive explanation 228 for newly input labeled instance 230, denoted xₑₓ. In FIG. 7A, decision boundary 700 separates instances into two regions based upon classes to which the instances are assigned by machine learning model 222, which illustratively is configured as a machine learning classifier. Datapoint 702 corresponds to instance xₑₓ. Instances represented by datapoints 704 are classified by machine learning model 222 in a different class or category. In FIG. 7B. NFN determiner 204 identifies instance xₑₓ, represented by datapoint 706, as the nearest flipped neighbor of datapoint 702 corresponding to instance xₑₓ. In FIG. 7C. CEG framework 200 determines contrastive explanation 228 corresponds to a hypothetical instance xₑₓ* represented by datapoint 708. xₑₓ* is a pertinent positive of xₑₓ⁺ but is a pertinent negative of xₑₓ. Its representative datapoint, datapoint 708, illustrated in FIG. 8 is adjacent or tangent to decision boundary 700, but on the other side from datapoint 702 corresponding to instance xₑₓ.

Thus, xₑₓ* is flipped relative to xₑₓ. That is, [symbol] (xₑₓ)≠ [symbol] (xₑₓ*)= [symbol] (xₑₓ⁺). xₑₓ* can be determined by an interpolation performed by interpolator 206. Interpolator 206, in certain embodiments, determines xₑₓ* according to the equation:

$${x}_{ex}^{*} = λ \cdot {x}_{ex} + ( 1 - λ ) \cdot {x}_{ex}^{+}$$

$$such that with$$

$${λ ∈ [ 1 , 0 )}^{d}$$

where λ is an optimal interpolation parameter corresponding to a d-dimensional vector. An optimal interpolation is defined as the datapoint that is closest to that of xₑₓ but having a different prediction. That is, if the datapoint corresponds to xₑₓ*, then C(xₑₓ*)=C(xₑₓ⁺) [symbol] (xₑₓ*)≠ [symbol] (xₑₓ*). The optimal interpolation can be determined by minimizing ∥λ∥.

In certain embodiments, CEG framework 200 implements a greedy heuristic (algorithm) for determining optimal interpolation parameter λ. The greedy heuristic includes the following procedures:
determine the vector difference δ=xₑₓ−xₑₓ⁺, where, as defined above, xₑₓ is a newly input instance for which machine learning model 222 generates a prediction (e.g., classification) and xₑₓ⁺ is its nearest flipped neighbor;
order the vector coordinates of δ by their absolute values to obtain δ_{ord};
for each coordinate i∈index(δ_{ord}), perform a binary search to determine the maximum λᵢ∈[0,1) that preserves the property [symbol] (xₑₓ)≠ [symbol] (xₑₓ*)= [symbol] (xₑₓ⁺); and
return the corresponding vector λ=[λᵢ].

The contrastive explanation generated by CEG framework 200 preserves the domain-specific semantics assigned to each instance. Category C(xₑₓ) determined by a machine learning classifier is flipped relative to category C(xₑₓ⁺), a different category, such that C(xₑₓ⁺)≠C(xₑₓ). Interpolation yields C(xₑₓ*), which is in the same class as C(xₑₓ⁺), such that C(xₑₓ*)=C(xₑₓ⁺). xₑₓ* is closer to xₑₓ than xₑₓ⁺ is. Nevertheless, xₑₓ* is flipped relative to xₑₓ. xₑₓ* is the nearest neighbor of xₑₓ but is the same class as xₑₓ⁺, C(xₑₓ*)=C(xₑₓ⁺). xₑₓ* corresponds to the minimal change that will flip the prediction for an instance from one prediction to another. The change is independent of and does not change the domain-specific semantics applied to each of the instance, and thus preserves their semantic relationships. The minimal change needed to flip xₑₓ corresponds to the straight-line distance between xₑₓ and xₑₓ*. The contrastive explanation reveals the minimal lack or absence of a feature or factor of an instance that will flip the prediction generated for the instance by a machine learning model.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or.” are open-ended expressions that are both conjunctive and disjunctive in operation unless explicitly stated otherwise. For example, each of the expressions “at least one of A, B and C.” “at least one of A, B, or C.” “one or more of A, B, and C.” “one or more of A, B, or C.” and “A, B, and/or C” means A alone, B alone, C alone, A and B together, A and C together, B and C together, or A, B and C together.

As defined herein, the term “automatically” means without user intervention.

As defined herein, the terms “includes,” “including.” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments.” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms “first.” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating, by a multi-label joint autoencoder, latent embeddings of a plurality of predictions of a machine learning model by positioning datapoints representing the plurality of predictions within an embedding space, wherein the datapoints are positioned within the embedding space based on a semantic labeling of each datapoint;
generating, based on the latent embeddings, a plurality of computer-searchable data structures; and
configuring a nearest flipped neighbor determiner based on the plurality of computer-searchable data structures for identifying a nearest flipped neighbor of datapoints within the embedding space.

2. The method of claim 1, wherein the method further comprises:
determining a contrastive explanation of a prediction generated by the machine learning model;
wherein the contrastive explanation corresponds to a nearest flipped neighbor determined by the nearest flipped neighbor determiner.

3. The method of claim 2, wherein the determining the contrastive explanation includes interpolating a datapoint within the embedding space representing the prediction and a datapoint within the embedding space representing the nearest flipped neighbor.

4. The method of claim 3, wherein the interpolating further includes generating an optimal interpolation parameter using a greedy heuristic.

5. The method of claim 1, wherein nearest flipped neighbor determiner is configured as k-d tree that can be searched to identify a nearest neighbor.

6. The method of claim 1, wherein the machine learning model is a machine learning classifier trained to generate predictions by assigning an input to one of multiple classes.

7. The method of claim 6, wherein the nearest flipped neighbor determiner comprises multiple k-d trees, each of the k-d trees uniquely corresponding to one of the multiple classes.

8. A system, comprising:
one or more processors configured to initiate operations including:
generating, by a multi-label joint autoencoder, latent embeddings of a plurality of predictions of a machine learning model by positioning datapoints representing the plurality of predictions within an embedding space, wherein the datapoints are positioned within the embedding space based on a semantic labeling of each datapoint;
generating, based on the latent embeddings, a plurality of computer-searchable data structures; and
configuring a nearest flipped neighbor determiner based on the plurality of computer-searchable data structures for identifying a nearest flipped neighbor of datapoints within the embedding space.

9. The system of claim 8, wherein the one or more processors are configured to initiate operations further including:
determining a contrastive explanation of a prediction generated by the machine learning model;
wherein the contrastive explanation corresponds to a nearest flipped neighbor determined by the nearest flipped neighbor determiner.

10. The system of claim 9, wherein the determining the contrastive explanation includes interpolating a datapoint within the embedding space representing the prediction and a datapoint within the embedding space representing the nearest flipped neighbor.

11. The system of claim 10, wherein the interpolating further includes generating an optimal interpolation parameter using a greedy heuristic.

12. The system of claim 8, wherein nearest flipped neighbor determiner is configured as k-d tree that can be searched to identify a nearest neighbor.

13. The system of claim 8, wherein the machine learning model is a machine learning classifier trained to generate predictions by assigning an input to one of multiple classes, and wherein the nearest flipped neighbor determiner comprises multiple k-d trees, each of the k-d trees uniquely corresponding to one of the multiple classes.

14. A computer program product, the computer program product comprising:
one or more computer-readable storage media and program instructions collectively stored on the one or more computer-readable storage media, the program instructions executable by a processor to cause the processor to initiate operations including:
generating, by a multi-label joint autoencoder, latent embeddings of a plurality predictions of a machine learning model by positioning datapoints representing the plurality of predictions within an embedding space, wherein the datapoints are positioned within the embedding space based on a semantic labeling of each datapoint;
generating, based on the latent embeddings, a plurality of computer-searchable data structures; and
configuring a nearest flipped neighbor determiner based on the plurality of computer-searchable data structures for identifying a nearest flipped neighbor of datapoints within the embedding space.

15. The computer program product of claim 14, wherein the program instructions are executable by the processor to cause the processor to initiate operations further including:
determining a contrastive explanation of a prediction generated by the machine learning model;
wherein the contrastive explanation corresponds to a nearest flipped neighbor determined by the nearest flipped neighbor determiner.

16. The computer program product of claim 15, wherein the determining the contrastive explanation includes interpolating a datapoint within the embedding space representing the prediction and a datapoint within the embedding space representing the nearest flipped neighbor.

17. The computer program product of claim 16, wherein the interpolating further includes generating an optimal interpolation parameter using a greedy heuristic.

18. The computer program product of claim 14, wherein nearest flipped neighbor determiner is configured as k-d tree that can be searched to identify a nearest neighbor.

19. The computer program product of claim 14, wherein the machine learning model is a machine learning classifier trained to generate predictions by assigning an input to one of multiple classes.

20. The computer program product of claim 19, wherein the nearest flipped neighbor determiner comprises multiple k-d trees, each of the k-d trees uniquely corresponding to one of the multiple classes.
